(19) United States
(12) Patent Application Publication
(10) Pub. No.: US 2009/0284124 A1
(43) Pub. Date: Nov. 19, 2009

(54) CATHODE COMPOSED OF MATERIALS WITH DIFFERENT ELECTRON WORKS FUNCTIONS

(76) Inventors: WOLFGANG KUTSCHERA, Aurachtal (DE); EBERHARD LENZ, Erlangen (DE); ERNST NEUMEIER, Aurachtal (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/427,865

(22) Filed: Apr. 22, 2009

(30) Foreign Application Priority Data
Apr. 22, 2008 (DE) 10 2008 020 163.4
Apr. 22, 2008 (DE) 10 2008 020 165.0

(51) Int. Cl. H01J 1/14

(52) U.S. Cl. 313/346 DC

(57) ABSTRACT

A cathode has a thermionic emitter composed of a material that emits electrons upon being heated, and an emission layer, composed of a material that has a lower electron work function than the material of the thermionic emitter, is applied on said thermionic emitter so as to at least partially cover the thermionic emitter. Such a cathode has a high electron emission with simultaneously improved focusing and a longer lifespan.

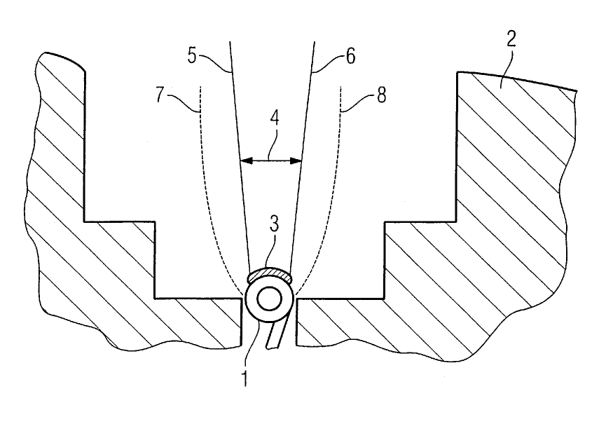

### BACKGROUND OF THE INVENTION

1. Field of the Invention

The invention concerns a cathode with a thermionic emitter made from a material that emits electrons upon being heated.

2. Description of the Prior Art

A cathode of the above type is described in DE 27 27 907 C2, for example.

The cathode known from DE 27 27 907 C2 has a rectangular surface emitter that consists of tungsten (W), tantalum (Ta) or rhenium (Re), for example, and has a layer thickness of 0.05 mm to 0.1 mm. The surface emitter (produced in a rolling process) has incisions that are arranged in alternation from two opposite sides, and transverse to the longitudinal direction. In operation of the x-ray tube embodying such a cathode, a heating voltage is applied to the surface emitter of the cathode, causing heating currents from 5 A to 15 A to flow so that electrons are emitted, that are accelerated in the direction of an anode. X-ray radiation is generated in the surface of the anode when the electrons strike the anode.

Specific configurations of the temperature distribution can be achieved by the shape, length and arrangement of the lateral incisions in the surface emitter according to DE 27 27 907 C2, since the heating of a body heated by current passage depends on the distribution of the electrical resistance across the current paths. Less heat is thus generated at points at which the electrically active plate cross-section of the surface emitter is greater than at points with a smaller cross-section (points with a greater electrical resistance).

A cathode that having a surface emitter made from rolled tungsten plate with a circular footprint (base) is disclosed in DE 199 14 739 C1. The surface emitter has a circular shape and is sub-divided into conductor traces running in spirals that are spaced apart from one another by incisions.

An increase in the performance (capacity) in the known cathodes is achieved by the surface emitter particularly quickly achieving its electron emission temperature by the use of so-called “push” currents. However, the material of the surface emitter reaches its load limit due to these high heating currents. Given a long and high thermal load, tears that run transverse to the weakest production direction of the surface emitter can form in the surface emitter, due to non-uniform texture produced, by the rolling in manufacturing. The use of rolled tungsten plates therefore represents an intrinsic weak point that can negatively affect the lifespan of the cathode.

The use of WRe26 (tungsten alloy with 26% rhenium) as a material for the surface emitter is unsuitable due to the low creep resistance of WRe26. The term “creep”, means the plastic deformation of a material under constant mechanical stress and increased temperature. Due to a resulting severe plastic deformation of the material, a low creep resistance is equivalent with a short lifespan of the surface emitter.

Another cathode is described in EP 0 059 238 B1. This known cathode is part of an x-ray tube and has a spiral-wound filament that emits electrons upon being heated.

This spiral-wound filament sits in a structure known as a focusing head (called a focus head in the following), whose inner edges and clearances are designed so that the electrons emitted from the spiral-wound filament strike the anode in a relatively narrow focal spot upon the application of a high voltage.

If it is now desired to increase the performance in x-ray tubes so that the focal spot size on the anode is reduced given the same (or somewhat increased) total electrical power, this is not possible in the present prior art because the focal spot size on the anode is significantly determined by the interaction of the variables
distance from the cathode to the anode,
level of the high voltage,
diameter of the spiral-wound filament and
temperature of the spiral-wound filament.

An optimization of these variables is achieved in present x-ray tubes. For example, an electrical power increase would always be associated with a disadvantage: a diameter increase of the spiral-wound filament would enlarge the focal spot; and a temperature increase (to increase the electron emission) with the same filament diameter would disproportionately shorten the lifespan of the spiral-wound filament due to overheating.

In the x-ray tube described in EP 0 059 238 B1, a shielding is provided that lies at a potential between half and the full anode potential, so a greater proportion of backscatter electrons is drawn from the focal spot to the anode. The load of the anode can thereby be increased. With an anode capable of being more highly loaded, the intensity of the x-ray radiation generated in the anode can be increased. The measure proposed in EP 0 059 238 B1 is relatively complicated in terms of construction.

### SUMMARY OF THE INVENTION

An object of the present invention is to provide a cathode with a high electron emission with the same improved focusing and higher lifespan.

The above object is achieved by a cathode according to the invention having a thermionic emitter made from a material that emits electrons upon being heated, wherein an emission layer, applied at least partially on the thermionic emitter, is made from a material that has a lower electron work function (Φ) than the material of the thermionic emitter. In the cathode according to the invention, the thermionic emitter is executed either as a spiral-wound filament or as a surface emitter.

In the cathode according to the invention, the thermionic emitter (composed of tungsten (W), tantalum (Ta) or rhenium (Re), for example) essentially serves as a substrate for the applied emission layer formed of a material having a lower electron work function than the material of the thermionic emitter. Given use of the typical materials (for example W, Ta, Re) for the thermionic emitter (substrate for the emission layer possessing a better electron emission), no changes relative to the previous installation steps are required in the installation of the thermionic emitter in the cathode according to the invention since, as before, a good welding capability of the current feed legs of the thermionic emitter is provided.

Due to the feature according to the invention to apply an emission layer that has a lower electron work function than the thermionic emitter at least partially on the thermionic emitter, a significantly higher electron emission can be realized without a temperature increase that would affect the lifespan of the thermionic emitter. X-ray tubes with the cathode according to the invention can therefore also be used in fields outside of medicine. The operating temperature of the thermionic emitter can even normally be lowered, and an electron emission as with a thermionic emitter made from tungsten, tantalum or rhenium is still achieved. A significant power increase is therefore achieved while simultaneously ensuring a long lifespan.

Since, in the cathode according to the invention, the thermionic emitter serves as a substrate for the emission layer, the thermionic emitter does not necessarily need to be composed of tungsten, tantalum or rhenium but can instead be composed also consist of a material that has a high electron work function and therefore a low electron emission. However, if the thermionic emitter is composed of tungsten, tantalum or rhenium, given a damaged or fatigued emission layer sufficiently high electron emission can still be realized by increasing the heating current that feeds the thermionic emitter.

In the scope of the invention, the emission layer can be applied to partially or completely cover the thermionic emitter. Given a partial coating, the thermionic emitter can be coated in a targeted manner with various emission layers that, for example, exhibit different physical properties. For example, a desired temperature distribution can be achieved in a simple manner in the thermionic emitter, In the individual case, manufacturing advantages can also result from a complete or a partial coating.

In an embodiment of the cathode according to the invention the emission layer is applied in the azimuthal region of the thermionic emitter. The term “azimuthal region”, means the emission region of the thermionic emitter from which the electrons are accelerated on a direct path toward the anode of the x-ray tube.

By applying the emission layer in the azimuthal region of the thermionic emitter, the focal spot geometry of the electrons striking the anode is particularly precisely delimited. A significantly more precisely defined intensity distribution therefore results in the focal spot. An increased quality of the generated x-ray image results therefrom.

A number of materials or a combination of these materials, or alloys of these materials, are suitable for the emission layer. For example, lanthanum (La), molybdenum (Mo), niobium (Nb), osmium (Os), ruthenium (Ru), tantalum (Ta), technetium (Tc) and thorium (Th) are among such suitable materials.

According to a further embodiment, the emission layer can be formed of carbon (C).

In a further embodiment is characterized in that the emission layer is composed of a metal compound of hafnium (Hf) with rhenium (Re).

Particularly advantageous are embodiments in which the emission layer is composed of boride that contains one of the following metals: hafnium (Hf), molybdenum (Mo), niobium (Nb), ruthenium (Ru), tantalum (Ta), titanium (Ti), zirconium (Zr).

In further embodiments the emission layer is composed of a carbide that contains one of the following metals: gadolinium (Gd), hafnium (Hf), lanthanum (La), molybdenum (Mo), niobium (Nb), osmium (Os), ruthenium (Ru), thorium (Th), titanium (Ti), uranium (U), vanadium (V), tungsten (W), yttrium (Y), zirconium (Zr).

The use of an emission layer composed of a nitride that contains cerium (Ce), hafnium (Hf), molybdenum (Mo), niobium (Nb), tantalum (Ta), thorium (Th), titanium (Ti), uranium (U), yttrium (Y) or zirconium (Zr) also represents an advantageous embodiment for a cathode.

A cathode with an emission layer made from a borocarbide that contains chromium (Cr), iron (Fe), gadolinium (Gd), hafnium (Hf), niobium (Nb), tantalum (Ta), thorium (Th), titanium (Ti) or uranium (U) is likewise an advantageous variant within the scope of the invention.

In further exemplary embodiments of the cathode according to the invention, the emission layer is composed of a mixed compound of one of the following metals with at least one substitutable metal partner: cerium (Ce), chromium (Cr), iron (Fe), gadolinium (Gd), hafnium (Hf), lanthanum (La), molybdenum (Mo), niobium (Nb), osmium (Os), ruthenium (Ru), tantalum (Ta), thorium (Th), titanium (Ti), uranium (U), vanadium (V), tungsten (W), yttrium (Y), zirconium (Zr). An example of an emission layer made of a mixed compound composed of one of the aforementioned metals with a substitutable metal partner is iron-chromium carbonitride [CN(Fe₁₋ₓ+Crₓ)].

In a particularly advantageous embodiment of the cathode according to the invention, the emission layer is composed of titanium diboride (TiB₂), an electrically conductive ceramic material.

Titanium diboride exhibits a number of advantages. Titanium diboride has a melting point of 3,220° C. and therefore is in the same range as tungsten (3,410° C.). Due to the ceramic character of TiB₂, just as good a high temperature resistance as in Tungsten (W) is provided in connection with the very high melting point, and therefore a comparably good vacuum capability is provided. The specific electrical resistance of titanium diboride (ρ=16 μΩ·cm) is on the order of tungsten (ρ=5.6 μΩ·cm). Moreover, the electron work function (Φ) approximately 0.5 eV less than that of tungsten, which amounts to approximately 4.9 eV. A thermionic emitter coated with titanium diboride therefore emits significantly more electrons at the same temperature than a thermionic emitter that consists exclusively of tungsten. Furthermore, titanium diboride has a thermal coefficient of expansion that differs only by approximately 3·10⁻⁶ from the value of tungsten and therefore lies very close to the coefficient of expansion of tungsten.

According to additional advantageous embodiments, lanthanum oxide (La₂O₃), yttrium oxide (Y₂O₃) or titanium carbide (TiC) can alternatively also be used as a material for the emission layer.

For specific application fields it can be appropriate to arrange a diffusion barrier layer—advantageously made from iridium (Ir) or tantalum carbide (TaC)—between the thermionic emitter and the emission layer.

According to an additional advantageous embodiment of the cathode according to the invention, the emission layer possesses a layer thickness of approximately 0.05 μm up to approximately 20 μm. A functionally sufficient coating is thereby always maintained on the entire electron-emitting region (diameter smaller than 10 mm) in a surface emitter, even after arcing.

In a thermionic emitter suitable for the cathode according to the invention, the emission layer (for example TiB₂, La₂O₃, Y₂O₃) is applied on the spiral-wound filament (for example W, Ta, Re) via laser ablation (PLD; pulsed laser deposition). An emission layer applied according to this method reliably adheres to the electron emission layer at operating temperatures of approximately 2,000° C.

If the thermionic emitter is executed as a surface emitter, after the application of the emission layer the incisions (which, for example, are arranged in alternation from two opposite sides and transversal to the longitudinal direction, or which exhibit a meandering structure) are generated in the surface emitter by means of laser cutting.

The electrical connection to the current feed lines made from TZM (titanium-zirconium-molybdenum; solid solution-hardened and particle-reinforced molybdenum base alloy) ensues as is conventional through the current feed legs of the thermionic emitter.

### BRIEF DESCRIPTION OF THE DRAWINGS

The single FIGURE shows an embodiment of the invention as a schematic section through a cathode in the region of its focus head.

### DESCRIPTION OF THE PREFERRED EMBODIMENTS

The cathode shown in the FIGURE has a thermionic emitter that, in the shown exemplary embodiment, is executed as a spiral-wound filament 1 and is arranged in a focus head 2.

The spiral-wound filament 1 is formed of a material that emits electrons upon being heated. In the shown exemplary embodiment, the spiral-wound filament 1 consists of tungsten (W). An emission layer 3 made from a material that possesses a lower electron work function (Φ) than the material (tungsten) of the spiral-wound filament 1 is applied on said spiral-wound filament 1.

Upon heating the spiral-wound filament 1, the emission layer 3 is also heated so that electrons from both the emission layer 3 and the spiral-wound filament 1 are accelerated towards an anode (not shown in the FIGURE).

In the shown exemplary embodiment, the emission layer 3 is applied in the azimuthal region 4 of the spiral-wound filament 1. “Azimuthal region”, means the emission region of the spiral-wound filament 1 from which the electrons are accelerated in a direct path toward the anode.

By the application of the emission layer 3 in the azimuthal region 4 of the spiral-wound filament 1, the focal spot geometry of the electrons striking the anode is particularly precisely delimited. A significantly more precisely defined intensity distribution therefore results in the focal spot of the anode. An increased quality of the generated x-ray image results from this.

In the presented cathode the emission layer applied on the spiral-wound filament 1 consists of titanium diboride (TiB₂), an electrically conductive ceramic material with an electron work function lower by approximately 0.5 eV than that of tungsten.

An electron stream (flow) (solid lines 5 and 6) emitted by the emission layer 3 is focused significantly more strongly relative to an electron stream (dashed lines 7 and 8) emitted by the spiral-wound filament 1. In the following the electron stream emitted by the emission layer 3 (in the azimuthal region 4) is designated as a primary electron stream, in contrast to which the adjacent electron streams that are simultaneously emitted are designated as secondary electron streams.

By the application of the emission layer 3 on the spiral-wound filament 1, the operating temperature of the spiral-wound filament 1 can be lowered such that the intensity of the primary electron stream (solid lines 5 and 6) emitted by the emission layer 3 exhibits the same value as in a conventional spiral-wound filament. Due to the decreased operating temperature, the spiral-wound filament 1 emits significantly fewer electrons in its uncoated regions; the intensities of the secondary electron streams (dashed lines 7 and 8) are correspondingly reduced. The relative ratio of the intensities of the secondary electron streams to the intensity of the primary electron stream is thereby reduced. Furthermore, the absolute values of the intensities of the secondary electron streams are so low that they are registered only at a fraction. A significantly more precisely defined intensity distribution therefore results in the focal spot, and the focal spot geometry of the electrons striking the anode is particularly precisely delimited. An increased quality of the generated x-ray image results from this.

The reduced operating temperature leads to a distinctly extended lifespan of the thermionic emitter (in the presented exemplary embodiment the spiral-wound filament 1).

If, in the cathode shown in the FIGURE, the operating temperature is not lowered relative to a conventional cathode, a significantly higher density of electrons can then be drawn off by the high voltage than is possible in a conventional cathode (cathode without emission layer with lower electron work function). A substantially higher electron emission thus can be achieved without a temperature increase that would affect the lifespan of the thermionic emitter. In this case as well the relative ratio of the intensities of the secondary electron streams to the intensity of the primary electron stream is reduced. An improvement of the image quality is therefore achieved even if the operating temperature is not lowered.

In an embodiment of the cathode with a surface emitter (not shown in the FIGURE; such as for the use of cathode of an x-ray tube for mammography apparatuses or the cathode of a rotary piston x-ray tube), only the inner part of the surface emitter is coated with an emission layer made from a material that has a lower electron work function than the material of the surface emitter. The electron emission from the borders of the surface emitter is therefore reduced absolutely or relatively in comparison with the azimuthal region, with the beneficial results for the image quality that have already been described for the example of the spiral-wound filament.

Although modifications and changes may be suggested by those skilled in the art, it is the intention of the inventors to embody within the patent warranted hereon all changes and modifications as reasonably and properly come within the scope of their contribution to the art.

We claim as our invention:

1. A cathode comprising:
a thermionic emitter comprised of a material that emits electrons upon being heated, said thermionic emitter having a surface from which said electrons are emitted; and
an emission layer applied on and covering at least a portion of said surface of said thermionic emitter, said emission layer being comprised of a material having a lower electron work function than the material of the thermionic emitter.

2. A cathode as claimed in claim 1 wherein said thermionic emitter is a spiral-wound filament.

3. A cathode as claimed in claim 1 wherein said thermionic emitter has a surface emitter structure.

4. A cathode as claimed in claim 1 wherein said emission layer is applied on an entirely of said surface of said thermionic emitter.

5. A cathode as claimed in claim 1 wherein said surface of said thermionic emitter has an azimuthal region, and wherein said emission layer is applied on said azimuthal region.

6. A cathode as claimed in claim 1 wherein said material of said emission layer is comprised of at least one emission layer material selected from the group consisting of lanthanum, molybdenum, niobium, osmium, ruthenium, tantalum, technetium and thorium.

7. A cathode as claimed in claim 6 wherein said material of said emission layer is an alloy of at least two of said emission layer materials.

8. A cathode as claimed in claim 1 wherein said emission layer consists of carbon.

9. A cathode as claimed in claim 1 wherein said emission layer consists of a metal compound of hafnium and rhenium.

10. A cathode as claimed in claim 1 wherein said emission layer consists of a boride containing a metal selected from the group consisting of hafnium, molybdenum, niobium, ruthenium, tantalum, titanium and zirconium.

11. A cathode as claimed in claim 1 wherein said emission layer consists of a carbide containing a metal selected from the group consisting of gadolinium, hafnium, lanthanum, molybdenum, niobium, osmium, ruthenium, thorium, titanium, uranium, vanadium, tungsten, yttrium and zirconium.

12. A cathode as claimed in claim 1 wherein emission layer consists of a nitride containing a metal selected from the group consisting of cerium, hafnium, molybdenum, niobium, tantalum, thorium, titanium, uranium, yttrium and zirconium.

13. A cathode as claimed in claim 1 wherein said emission layer is comprised of a borocarbide containing a metal selected from the group consisting of chromium, iron, gadolinium, hafnium, niobium, tantalum, thorium, titanium and uranium.

14. A cathode as claimed in claim 1 wherein said emission layer is comprised of a mixed compound of a metal and at least one substitutable metal partner selected from the group consisting of cerium, chromium, iron, gadolinium, hafnium, I lanthanum, molybdenum, niobium, osmium, ruthenium, tantalum, thorium, titanium, uranium, vanadium, tungsten, yttrium and zirconium.

15. A cathode as claimed in claim 1 wherein said emission layer consists of titanium, diboride.

16. A cathode as claimed in claim 1 wherein said emission layer consists of lanthanum oxide.

17. A cathode as claimed in claim 1 wherein said emission layer consists of yttrium oxide.

18. A cathode as claimed in claim 1 wherein said emission layer consists of titanium carbide.

19. A cathode as claimed in claim 1 wherein said emission layer consists of iron-chromium carbonitride [CN(Fe₁₋ₓ+Crₓ)].

20. A cathode as claimed in claim 1 comprising a diffusion barrier layer between said surface of said thermionic emitter and said emission layer.

21. A cathode as claimed in claim 20 wherein said diffusion barrier layer consists of iridium.

22. A cathode as claimed in claim 20 wherein said diffusion barrier layer consists of tantalum carbide.

23. A cathode as claimed in claim 1 wherein said emission layer has a layer thickness in a range between 0.05 through 20 μm.
